(19) United States
(12) Patent Application Publication
(10) Pub. No.: US 2020/0149746 A1
(43) Pub. Date: May 14, 2020

(54) OVEN

(71) Applicant: SAMSUNG ELECTRONICS CO., LTD., Suwon-si, Gyeonggi-do (KR)

(72) Inventors: Kyung Hwan LEE, Suwon-si (KR); Han Seong KANG, Hwaseong-si (KR); Han Beom KOO, Seoul (KR); Yeong Hyeok KIM, Seoul (KR); Duck Jin SUNG, Suwon-si (KR); Hyun Ju LEE, Suwon-si (KR); Ji Ho JEONG, Hwaseong-si (KR); Pung Yeun CHO, Suwon-si (KR); Hyung-Jin KIM, Suwon-si (KR); Soo Hyoung HEO, Suwon-si (KR)

(73) Assignee: SAMSUNG ELECTRONICS CO., LTD., Suwon-si, Gyeonggi-do (KR)

(21) Appl. No.: 16/609,030

(22) PCT Filed: Apr. 17, 2018
(86) PCT No.: PCT/KR2018/004430

§ 371 Date: Oct. 28, 2019

(30) Foreign Application Priority Data
Apr. 28, 2017 (KR) 10-2017-0055710

(51) Int. Cl. F24C 15/02; F24C 15/04; E05B 1/00; E06B 3/26

(52) U.S. Cl. CPC F24C 15/02; F24C 15/04; E06B 2003/2615; E06B 3/2605; E05B 1/0015

(57) ABSTRACT

Provided is an oven including a door for opening and closing a cooking chamber, in which a locking portion provided on a glass holder for supporting an outer glass moves along a locking slot provided in a chassis to be fitted to the locking slot, so that assembly of the door is facilitated.

### TECHNICAL FIELD

The present disclosure relates to an oven, and relates to an oven having a door for opening and closing a cooking chamber.

### BACKGROUND ART

In general, an oven is an appliance that includes a main body provided with a cooking chamber, a heating device for applying heat to the cooking chamber, and a door for opening and closing the cooking chamber, and cooks food inside the cooking chamber using heat generated by the heating device in a state in which the cooking chamber is closed by the door.

The oven may be classified into an electric oven, a gas oven and a microwave oven according to the type of the heating device. The electric oven uses an electric heater as a heat source, the gas oven uses heat from gas as a heat source, and uses heat of friction of water molecules by high frequency generated in a magnetron as a heat source.

The door has one end rotatably installed at one side of a main body, and the other end provided with a handle that allows a user to easily apply a force to the door.

### DISCLOSURE

### Technical Problem

The present disclosure is directed to providing an oven having a door easily assembled thereon.

The present disclosure is directed to providing an oven capable of facilitating installation and separation of a handle on a door.

### Technical Solution

One aspect of the present disclosure provides an oven including: a main body having a cooking chamber; and a door configured to open and close the cooking chamber, wherein the door includes an outer glass forming a front side of the door, a chassis forming a rear side of the door, and a glass holder attached to a rear surface of the outer glass and coupled to the chassis, wherein one of the chassis and the glass holder includes a plurality of locking portions, and the other one of the chassis and the glass holder includes a plurality of locking slots with which the plurality of locking portions moved are locked.

The door may open or close the cooking chamber by rotating with respect to a lower end of thereof, the plurality of locking slots may extend in an upper and lower side direction, and the plurality of locking portions may be inserted into the plurality of locking slots by the glass holder being moved upward.

The glass holder may include a plurality of locking protrusions arranged at opposite sides thereof to be spaced above and below each other, and the chassis may include a plurality of locking slots arranged at opposite sides thereof to be spaced above and below each other.

The plurality of locking protrusion may include a hook formed upward, and the locking slot may have a width gradually decreasing as being directed upward.

The glass holder may be provided with at least one seating portion extending backward from a lower end thereof, the chassis may be provided in a lower surface thereof with a seating groove formed in a concave manner to correspond to the fastening portion and allow the seating portion to be seated thereon, and the seating portion may be fixed to the seating groove through a fastening member.

The door may include a door portion covering the cooking chamber, a handle mounting portion formed in an upper portion of the door portion in a concave manner, and a handle mounted on the handle mounting portion.

The outer glass may form a front side of the door portion, and the handle mounting portion may be formed on an upper portion of the chassis protruding upward of the outer glass.

The chassis may include a pair of fixing portions protruding forward from the handle mounting portion, and the handle may include a pair of fixing grooves corresponding to the pair of fixing portions, a pair of fastening portions formed at opposite side ends thereof in a concave manner, and a pair of caps covering the pair of fastening portions, respectively, and the pair of fixing portions may include a plurality of fastening holes formed at positions corresponding to positions of a plurality of fastening holes of the pair of fastening portions.

The handle may include a cover portion installed to cover the handle mounting portion, a handle portion disposed to be spaced apart forward of the cover portion, and a pair of connecting portions connecting opposite ends of the cover portion to opposite ends of the handle portion, wherein the fixing grooves may be formed by gaps between the opposite ends of the cover portion and the pair of connecting portions.

The cover portion and the handle portion may be disposed to be spaced apart in parallel from each other.

The glass holder may include a metal sheet having a rectangular ring shape to form a holder through hole at an inner side thereof.

Another aspect of the present disclosure provides an oven including: a main body having a cooking chamber; and a door configured to open and close the cooking chamber, wherein the door includes a door portion covering the cooking chamber, a handle mounting portion formed in one end of the door portion in a concave manner, and a handle mounted on the handle mounting portion, wherein the handle mounting portion includes a pair of fixing portions protruding forward, the handle includes a pair of fixing grooves corresponding to the pair of fixing portions, a pair of fastening portions formed at opposite side ends thereof in a concave manner, and a pair of caps covering the pair of fastening portions, respectively, and the pair of fixing portions includes a plurality of fastening holes formed at positions corresponding to positions of a plurality of fastening holes of the pair of fastening portions.

The handle may extend in a left and right side direction, and the fastening portions may be provided at a left side end and a right side end of the handle, and the caps may be coupled to the left side end and the right side end of the handle, respectively.

The fastening portions may be provided at an upper end and a lower end of the handle, and the caps may be coupled to the upper end and the lower end of the handle.

### Advantageous Effects

As described above, an oven according to one aspect of the present disclosure can facilitate assembly of a door by installing a glass holder for supporting an outer glass on a chassis through a locking portion being inserted into a locking slot according to movement of the glass holder.

In addition, an oven according to one aspect of the present disclosure can facilitate separation of a handle by separating caps installed at opposite sides of the handle such that fastening members fixing the handle are exposed.

### DESCRIPTION OF DRAWINGS

FIG. 1 is a perspective view illustrating an oven according to the first embodiment of the present disclosure.

FIG. 2 is a perspective view illustrating a door used for the oven according to the first embodiment of the present disclosure.

FIG. 3 is an exploded perspective view illustrating the door used for the oven according to the first embodiment of the present disclosure.

FIG. 4 is a partially enlarged perspective view illustrating a configuration for coupling a glass holder and a chassis in the door used for the oven according to the first embodiment of the present disclosure.

FIGS. 5 to 8 are cross-sectional views sequentially illustrating a process in which the glass holder is coupled to the chassis in the door used for the oven according to the first embodiment of the present disclosure.

FIG. 9 is an exploded perspective view illustrating installation of a handle in the door used for the oven according to the first embodiment of the present disclosure.

FIG. 10 is a bottom perspective view illustrating the handle in the door used for the oven according to the first embodiment of the present disclosure.

FIG. 11 is a partially enlarged perspective view illustrating an installation structure of the handle in the door used for the oven according to the first embodiment of the present disclosure.

FIG. 12 is a cross-sectional view illustrating the installation structure of the handle in the door used for the oven according to the first embodiment of the present disclosure.

FIG. 13 is a perspective view illustrating an oven according to the second embodiment of the present disclosure.

FIG. 14 is an exploded perspective view illustration the installation of a handle in a door used for the oven according to the second embodiment of the present disclosure.

### MODES OF THE DISCLOSURE

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

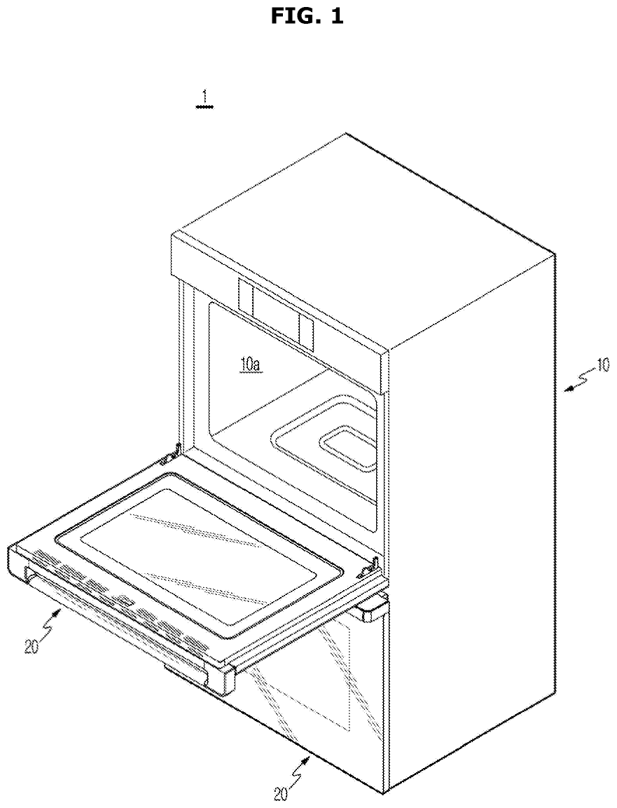

Referring to FIG. 1, an oven 1 includes a main body 10 provided with a cooking chamber 10a, and a door 20 for opening and closes the cooking chamber 10a. The cooking chamber 10a is formed inside the main body 10, a front side of which is partly opened. The door 20 is rotatably installed on the front of the main body 10 to open and close the cooking chamber 10a.

The main body 10 is formed in the shape of a rectangular housing extending in an upper and lower side direction, and includes two cooking chambers 10a arranged up and down.

The door 20 is provided as two doors 20 to open and close the two cooking chambers 10a, respectively. The doors 20 have lower ends thereof rotatably installed on the main body 10. Accordingly, the doors 20 rotate in a front and rear side direction with respect to the lower ends thereof, to open and close the cooking chambers 10a, respectively.

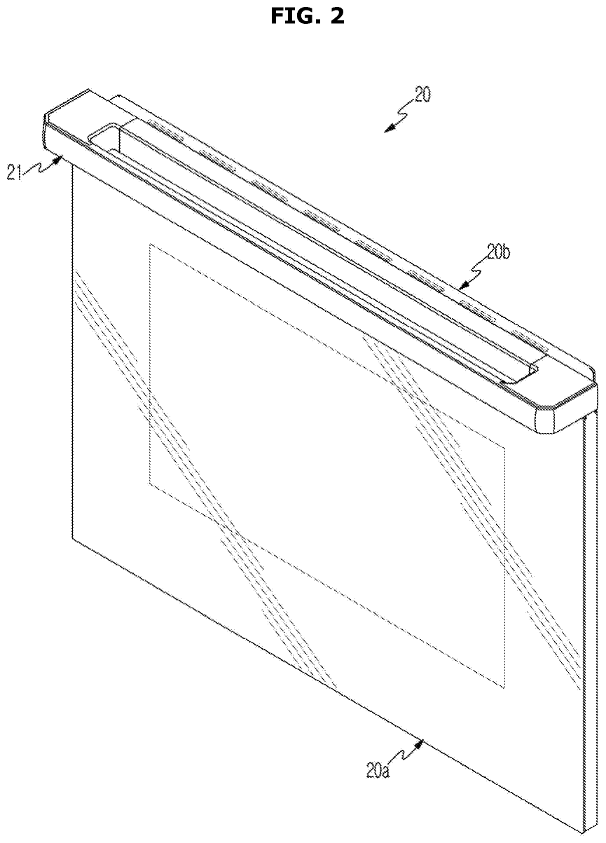

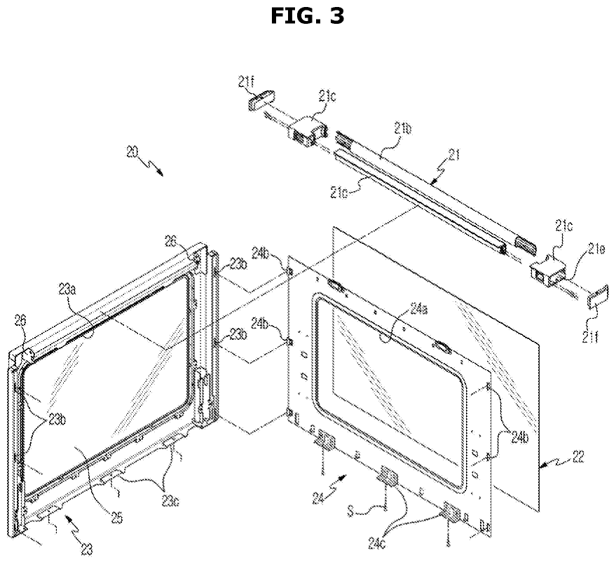

Referring to FIGS. 2 to 3, the door 20 has a door portion 20a covering the cooking chamber 10a, a handle mounting portion 20b provided on an upper portion of the door portion 20a and having a handle 21, which will be described below, mounted thereto, and the handle 21 coupled to the handle mounting portion 20b.

The door 20 includes an outer glass 22 forming a front side of the door portion 20a, a chassis 23 forming a rear side of the door 20, and a glass holder 24 attached to a rear surface of the outer glass 22 and coupled to the chassis 23. The handle mounting portion 20b is formed on an upper portion of the chassis 23 protruding upward of the outer glass 22.

The outer glass 22 is formed of a rectangular plate-shaped glass plate. The outer glass 22 is preferably formed of tempered glass to have sufficient strength.

The chassis 23 is formed of a plate in the form of a rectangular ring having a hole provided therein such that a hole at an inside of the chassis 23 forms a chassis through hole 23a that allows a user to observe the inside of the cooking chamber 10a from the outside. The chassis 23 is formed of metal, such as aluminum, that is light and has sufficient strength. The door 20 includes an inner glass 25 disposed to cover the chassis through hole 23a. The inner glass 25 is formed of a glass plate and a plurality of the inner glasses 25 are arranged in a front and rear side direction. Three inner glasses 25 may be arranged to be spaced apart in a front and rear side direction.

In addition, although not shown in the drawings, the door 20 includes hinge units installed at both lower sides of the chassis 23, and the door 20 is rotatably installed on the main body 10 through the hinge units.

The glass holder 24 is attached to a rear surface of the outer glass 22 to support the outer glass 22. Similar to the chassis 23, the glass holder 24 is formed of a plate having a rectangular ring shape with a hole formed at an inner side thereof to form a holder through hole 24a that allows a user to observe the inside of the cooking chamber 10a from the outside. In addition, the glass holder 24 is formed of a metal such as aluminum that is light and has sufficient strength.

As such, the glass holder 24 is formed of a metal plate having a rectangular ring shape, to thereby form the holder through hole 24a at an inner side thereof while a sufficiently securing an attachment area between the outer glass 22 and the glass holder 24. That is, the glass holder 24 described above has a structure for allowing the outer glass 22 to be used for the door 20 of the large oven 1.

The glass holder 24 is formed to have a size smaller than that of the outer glass 22, and the front surface of the glass holder 24 is attached to the rear surface of the outer glass 22 through an adhesive (not shown). As the adhesive, a heat resistant material, such as silicone, is used.

The chassis through hole 23a and the holder through hole 24a are formed in sizes and shapes corresponding to each other, and the outer glass 22 and the inner glass 25 are formed of a glass plate as described above. Accordingly, the user may observe the inside of the cooking chamber 10a from the outside through the chassis through hole 23a and the holder through hole 24a. The outer glass 22 and the inner glass 25 also serve to suppress leakage of heat to the outside through the chassis through hole 23a.

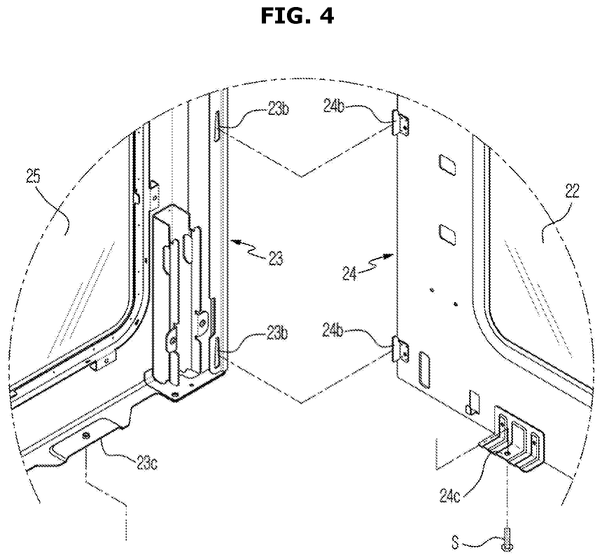

The glass holder 24 is fitted to the chassis 23 by moving upward. Referring to FIGS. 3 and 4, the glass holder 24 includes a locking portion 24b protruding to the rear side, and the chassis 23 includes a locking slot 23b into which the locking portion 24b is fitted.

The locking portion 24b is provided at an upper end thereof with a hook directed upward, and a plurality of the locking portions 24b are arranged at opposite sides of the glass holder 24a to be spaced apart above and below each other. The locking portion 24b is provided as three units thereof on each side of the rear surface of the glass holder 24.

The locking slot 23b extends in an upper and lower side direction, and a plurality of the locking slots 23b are arranged above and below each other on each side of the chassis 23 to correspond to the plurality of locking portions 24b. The locking slot 23b is provided as three units thereof on each side of the front surface of the chassis 23, and has a width gradually decreasing as being directed upward.

The glass holder 24 is fixed to the chassis 23 to thereby stably maintain a state in which the glass holder 24 is installed on the chassis 23.

To this end, the glass holder 24 includes a seating portion 24c extending from the lower end thereof to the rear side, and the chassis 23 includes a seating recess 23c formed in the lower surface thereof in a concave manner to correspond to the seating portion 24c. Each of the seating portion 24c and the seating recess 23c is provided in three units at positions corresponding to each other. The seating portion 24c is provided with a fastening hole at a position corresponding to a position of a fastening hole of the seating recess 23c, so that a fastening member S, such as a screw, is installed in a state in which the seating portion 24c is seated in the seating recess 23c, the seating portion 24c is fixed to the seating groove 23c.

Hereinafter, a process of coupling the glass holder 24 to the chassis 23 is described with reference to the drawings.

First, the outer glass 22 is attached to the rear surface of the glass holder 24, and the hinge unit and the inner glass 25 are installed in the chassis 23.

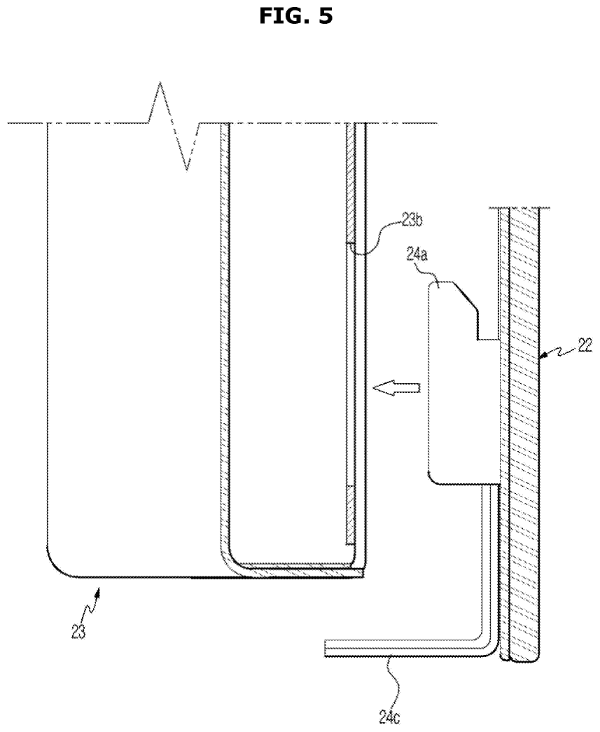

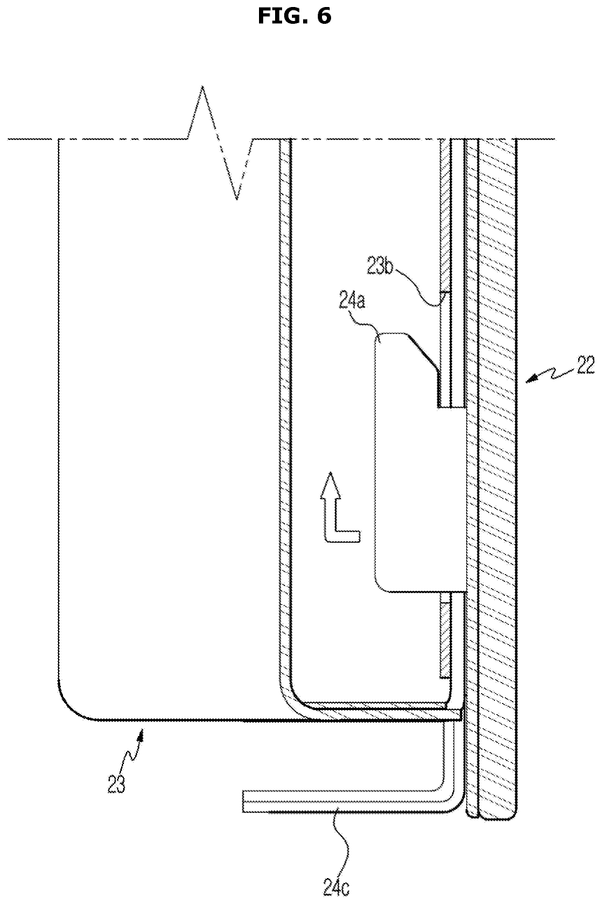

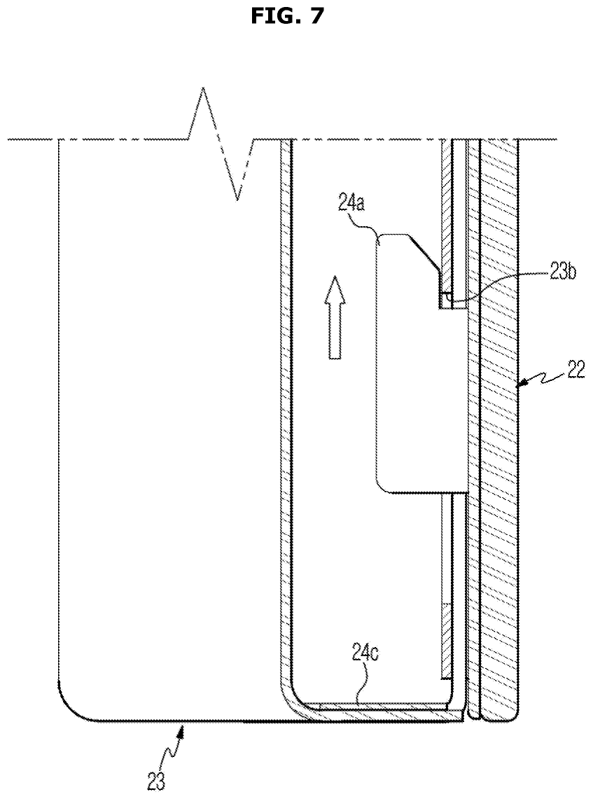

Thereafter, referring to FIGS. 5 and 6, the glass holder 24 is moved in a direction toward the rear side of the chassis 23 such that the locking portions 24b are inserted into the locking slots 23b. As the glass holder 24 is moved upward, the upper end of the hook-shaped locking portion 24b is fitted to and engaged with the locking slot 23b as shown in FIG. 7. In the state in which the locking portion 24b is engaged with the locking slot 23b, the forward movement of the glass holder 24 is restricted by the locking portion 24b and the locking slot 23b.

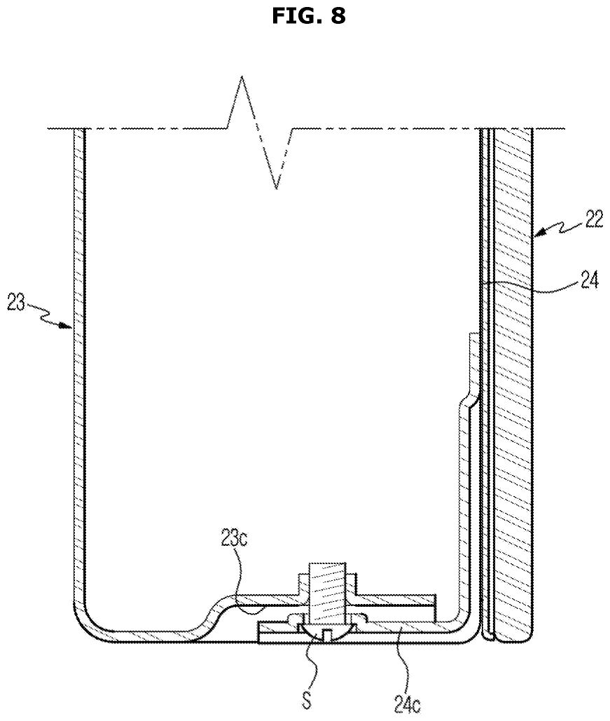

As described above, with the glass holder 24 being moved upward, the seating portion 24c is seated in the seating groove 23c. In this state, the seating portion 24c is fixed to the seating groove 23c through the fastening member S, the downward movement of the glass holder 24 is restricted by the fastening member S as shown in FIG. 8 by the fastening member S. Accordingly, the glass holder 24 is fixed to the chassis 23 and thus is not moved.

As described above, after the glass holder 24 with the outer glass 22 attached thereto is fitted to the chassis 23, the seating portion 24c is fixed to the seating groove 23c through the fastening member S, so that the assembly of the door 20 is completed. Accordingly, the assembly of the door 20 is simplified.

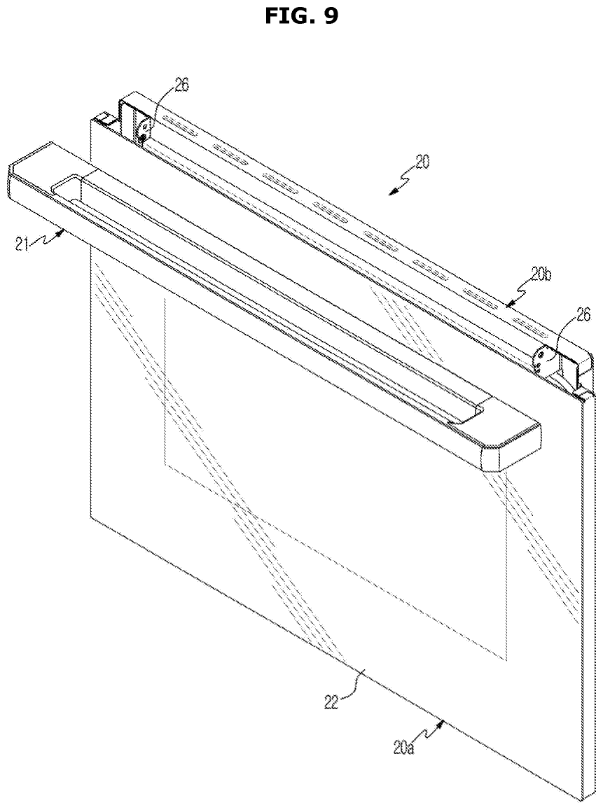

The handle 21 extends in a left and rear side direction as shown in FIG. 9, and is coupled to an upper portion of the main body 10 such that the user easily rotates the door 20 with respect to the lower end of the door 20.

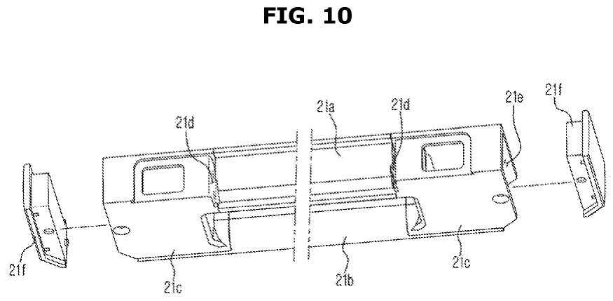

Referring to FIGS. 2 and 10, the handle 21 includes a cover portion 21a coupled to cover the handle mounting portion 20b, which has been described above, a handle portion 21b disposed to be spaced apart forward of the cover portion 21a, and a pair of connecting portions 21c connecting opposite ends of the cover portion 21a to opposite ends of the handle portion 21b. The cover portion 21a and the handle portion 21b are disposed to be spaced apart in parallel from each other, and the connecting portions 21c connect opposite side ends of the cover portion 21a to opposite side ends of the handle portion 21b.

The handle mounting portion 20b includes a pair of fixing portions 26a for installing the handle 21. The fixing portion 26 protrudes forward from the handle mounting portion 20b, and is provided in each of the opposite sides of the handle mounting part 20b to correspond to each end portion of the handle 21.

The handle 21 includes two fixing grooves 21d corresponding to the fixing portions 26. In the embodiment, the fixing grooves 21d are formed by gaps between the opposite ends of the cover portion 21a and the connecting portions 21c.

In order to fix the handle 21, the handle 21 includes fastening portions 21e formed at opposite side ends thereof in a concave manner, and a pair of caps 21f covering the fastening portions 21e. Since the handle 21 extends in a left and right side direction, the fastening portions 21e are provided a left side end and a right side end of the handle 21. Here, since the left side end and the right side end of the handle 21 are formed by the connecting portions 21c, the fastening portions 21e are provided at the connecting portions 21c, respectively.

The fixing portions 26 includes a plurality of fastening holes formed at positions corresponding to positions of fastening holes of the fastening portions 21e such that the fixing portion 26 and the fastening portion 21e are fixed to each other through a fastening member S. Each of the fixing portion 26 and the fastening portion 21e has two fastening holes, to more stably prevent the movement of the handle 21.

Thereafter, a process of installing the handle 21 on the handle mounting portion 20b will be described with reference to drawings.

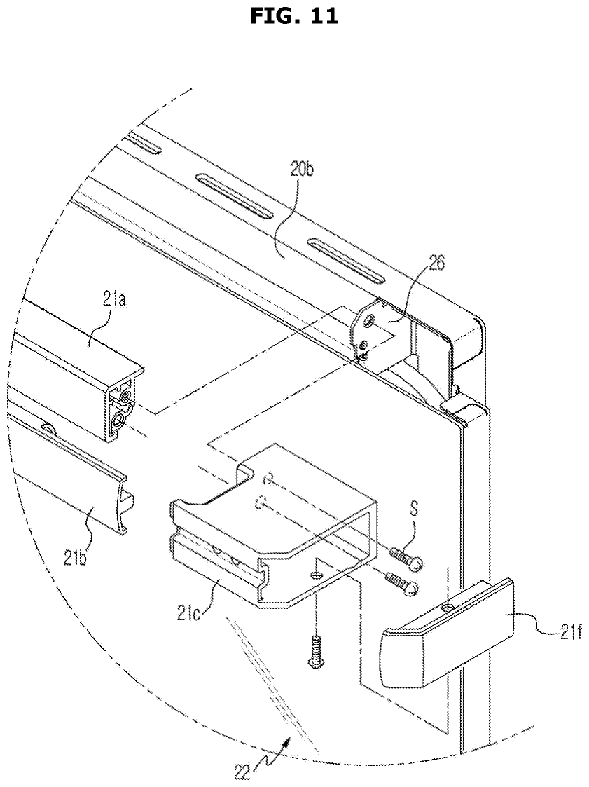

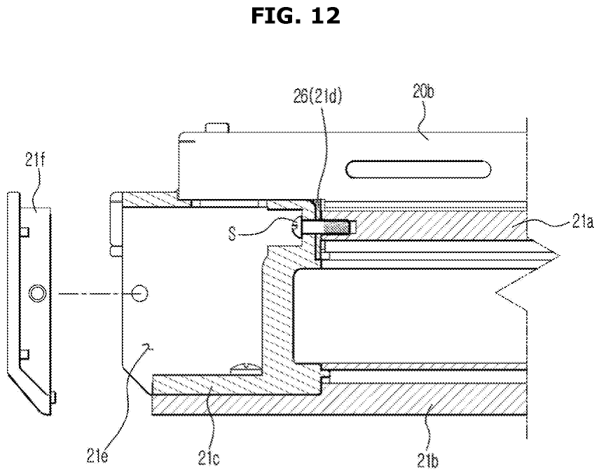

Referring to FIGS. 11 and 12, in a state in which the cover portion 21a and the handle portion 21b are arranged in parallel to each other, the connecting portions 21c are coupled to opposite ends of the cover portion 21a and the handle portion 21b. Although not shown in the drawings, the cover portion 21a and the handle portion 21b may be coupled to the connecting portion 21c in a snap fit manner.

In the process of coupling the cover portion 21a and the handle portion 21b to the connecting portion 21c, the connecting portion 21c and the cover portion 21a are spaced apart from each other to correspond to the fixing portion 26 at a predetermined area, generating a gap, which forms the above-described fixing groove 21d.

When the handle 21 is moved in a direction toward the rear side of the handle mounting portion 20b to seat the cover portion 21a of the handle 21 on the handle mounting portion 20b, the fixing portion 26 is fixed to the fixing groove 21d.

In this state, when fastening members S, such as screws, are fastened to the fastening holes provided in the fastening portion 21e and the fixing portion 26, the fastening portion 21e and the fixing portion 26 are fixed to each other, so that the cover portion 21a is fixed to the handle mounting portion 20b.

Subsequently, when the caps 21f are installed on the opposite sides of the handle 21 to close the fastening portions 21e, the fastening members S installed inside the fastening portion 21e are hidden by the caps 21f. Accordingly, the appearance of the handle 21 is improved.

In addition, when the handle 21 needs to be removed, the two caps 21f are separated from the opposite ends of the handle 21 to expose the fastening members S, and then the fastening members S are loosened through a driver or the like, so that the fastening portion 21e and the fixed portion 26 are separated from each other. In this state, when the handle 21 is moved to the front side, the handle 21 is separated from the handle mounting portion 20b. That is, with this structure, only the handle 21 may be easily separated from the handle mounting portion 20b without disassembling the door 20 as a whole.

Although the glass holder 24 is illustrated as being coupled to the chassis 23 by moving upward, the present disclosure is not limited thereto. That is, the locking slot may extend in a left and right side direction such that the glass holder is coupled to the chassis by moving in a left and right side direction.

In this case, the seating portion extends from one end of the glass holder to the rear side, and the seating recess is provided on one side of the glass holder.

In the above description, the door 20 has the lower end thereof rotatably installed on the main body 10 and thus rotates about the lower end thereof to open and close the cooking chamber 10a, but the present disclosure is not limited thereto.

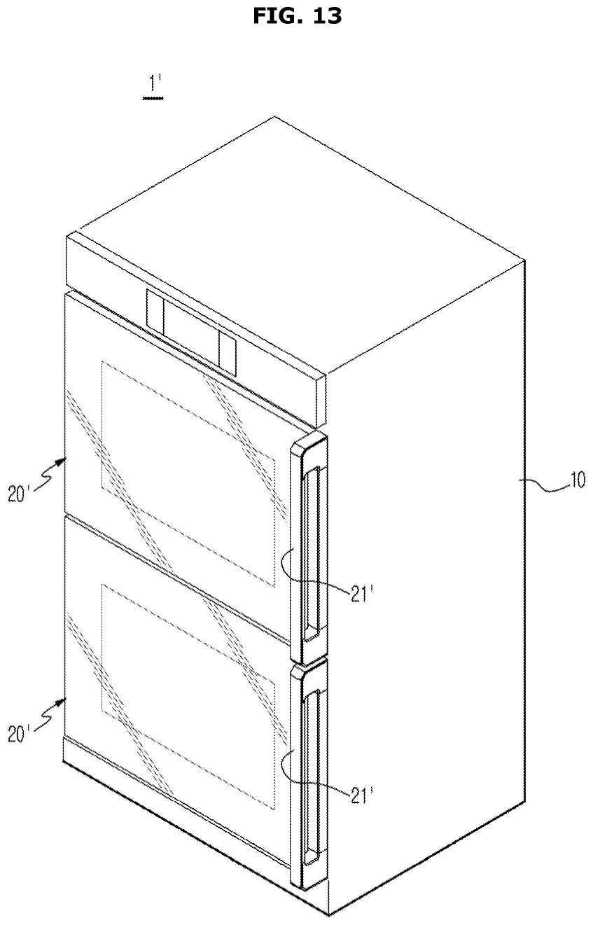

Referring to FIG. 13, in an oven 1′ according to the second embodiment of the present disclosure, a door 20′ may rotate about a lateral side thereof to open and close the cooking chamber 10a.

In FIG. 13, a left side end of the door 20 is rotatably installed at the main body 10, and the handle 21 is installed at a right side end of the door 20 opposite to the left side end.

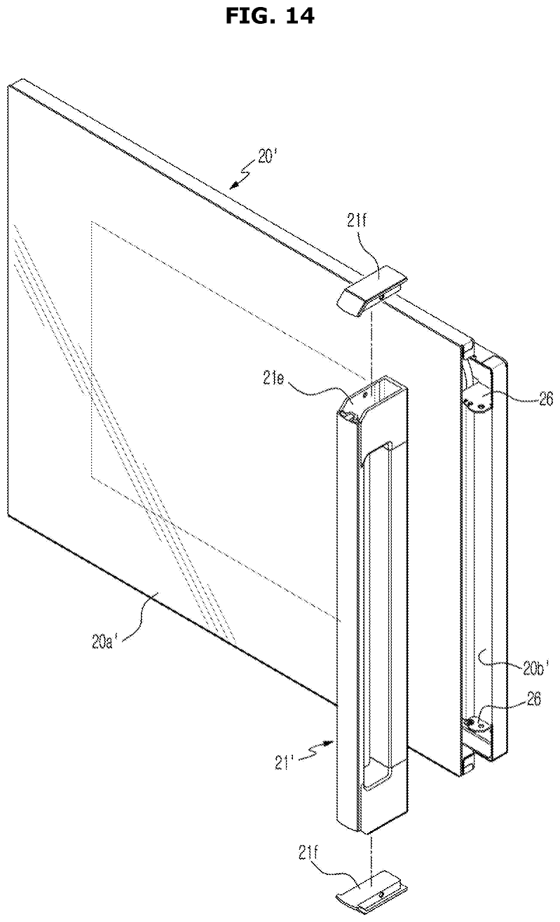

The handle 21 extends in an upper and lower side direction, and the fastening portions 21e are formed at an upper end and a lower end of the handle 21 in a concave manner as shown in FIG. 14. In addition, the caps 21f are provided to cover the fastening portions 21e provided at the upper and lower ends of the handle 21, respectively.

Accordingly, when there is a need to remove the handle 21, the caps 21f provided at the upper and lower ends of the handle 21 are separated to open the fastening portions 21e, and then the fastening members S are loosened through the open fastening portions 21e, so that the handle 21 is separated from the handle mounting portion 20b.

Although the glass holder 24 is illustrated as including the locking portions 24b, and the chassis 23 is illustrated as including the locking slots 23b, the present disclosure is not limited thereto. That is, the glass holder may include locking slots, and the chassis may include locking portions.

Although the present disclosure has been described with reference to the embodiments, a person of ordinary skill in the art should appreciate that various modifications, equivalents, and other embodiments are possible without departing from the scope and sprit of the present disclosure.

1. An oven comprising:
a main body having a cooking chamber; and
a door configured to open and close the cooking chamber,
wherein the door includes an outer glass forming a front side of the door, a chassis forming a rear side of the door, and a glass holder attached to a rear surface of the outer glass and coupled to the chassis,
wherein one of the chassis and the glass holder includes a plurality of locking portions, and the other one of the chassis and the glass holder includes a plurality of locking slots with which the plurality of locking portions moved are locked.

2. The oven of claim 1, wherein the door opens or closes the cooking chamber by rotating with respect to a lower end of thereof,
the plurality of locking slots extend in an upper and lower side direction, and
the plurality of locking portions are inserted into the plurality of locking slots by the glass holder being moved upward.

3. The oven of claim 2, wherein the glass holder includes a plurality of locking protrusions arranged at opposite sides thereof to be spaced above and below each other, and
the chassis includes a plurality of locking slots arranged at opposite sides thereof to be spaced above and below each other.

4. The oven of claim 2, wherein the plurality of locking protrusion includes a hook formed upward, and
the locking slot has a width gradually decreasing as being directed upward.

5. The oven of claim 2, wherein the glass holder is provided with at least one seating portion extending backward from a lower end thereof,
the chassis is provided in a lower surface thereof with a seating groove formed in a concave manner to correspond to the fastening portion and allow the seating portion to be seated thereon, and
the seating portion is fixed to the seating groove through a fastening member.

6. The oven of claim 2, wherein the door includes a door portion covering the cooking chamber, a handle mounting portion formed in an upper portion of the door portion in a concave manner, and a handle mounted on the handle mounting portion.

7. The oven of claim 6, wherein the outer glass forms a front side of the door portion, and the handle mounting portion is formed on an upper portion of the chassis protruding upward of the outer glass.

8. The oven of claim 6, wherein the chassis includes a pair of fixing portions protruding forward from the handle mounting portion, and
the handle includes a pair of fixing grooves corresponding to the pair of fixing portions, a pair of fastening portions formed at opposite side ends thereof in a concave manner, and a pair of caps covering the pair of fastening portions, respectively, and
the pair of fixing portions include a plurality of fastening holes formed at positions corresponding to positions of a plurality of fastening holes of the pair of fastening portions.

9. The oven of claim 8, wherein the handle includes a cover portion installed to cover the handle mounting portion, a handle portion disposed to be spaced apart forward of the cover portion, and a pair of connecting portions connecting opposite ends of the cover portion to opposite ends of the handle portion, and
the fixing grooves are formed by gaps between the opposite ends of the cover portion and the pair of connecting portions.

10. The oven of claim 9, wherein the cover portion and the handle portion are disposed to be spaced apart in parallel from each other.

11. The oven of claim 2, wherein the glass holder includes a metal sheet having a rectangular ring shape to form a holder through hole at an inner side thereof.

12. An oven comprising:
a main body having a cooking chamber; and
a door configured to open and close the cooking chamber,
wherein the door includes a door portion covering the cooking chamber, a handle mounting portion formed in one end of the door portion in a concave manner, and a handle mounted on the handle mounting portion,
the handle mounting portion includes a pair of fixing portions protruding forward,
the handle includes a pair of fixing grooves corresponding to the pair of fixing portions, a pair of fastening portions formed at opposite side ends thereof in a concave manner, and a pair of caps covering the pair of fastening portions, respectively, and
the pair of fixing portions includes a plurality of fastening holes formed at positions corresponding to positions of a plurality of fastening holes of the pair of fastening portions.

13. The oven of claim 12, wherein the handle includes a cover portion installed to cover the handle mounting portion, a handle portion disposed to be spaced apart forward of the cover portion, and a pair of connecting portions connecting opposite ends of the cover portion to opposite ends of the handle portion, and
the fixing grooves are formed by gaps between the opposite ends of the cover portion and the pair of connecting portions.

14. The oven of claim 12, wherein the handle extends in a left and right side direction, and
the fastening portions are provided at a left side end and a right side end of the handle, and
the caps are coupled to the left side end and the right side end of the handle, respectively.

15. The oven of claim 12, wherein the fastening portions are provided at an upper end and a lower end of the handle, and
the caps are coupled to the upper end and the lower end of the handle.
